(19) United States
(12) Patent Application Publication
(10) Pub. No.: US 2009/0298020 A1
(43) Pub. Date: Dec. 3, 2009

(54) SYSTEMS AND METHODS FOR IMPROVING USER EFFICIENCY WITH HANDHELD DEVICES

(75) Inventors: Gerardine Mary Corcoran, Wayne, PA (US); Shane Brandon Hennessy, New Freedom, PA (US); Stephen Mark Jones, Alpharetta, GA (US); Michael Todd Kisamore, Stewartstown, PA (US); Roy E. Lancraft, Phoenix, MD (US); Devidas Ramdas Pitta, Pune (IN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 12/132,189

(22) Filed: Jun. 3, 2008

(51) Int. Cl. G09B 19/00

(52) U.S. Cl. 434/118

(57) ABSTRACT

A system, method, and computer program product are provided for training users how to operate handheld electronic devices and/or their respective applications, wherein the handheld electronic device may receive an expected input associated with an application executing on the handheld from a computing device. The handheld may then receive an actual input from a user of the handheld electronic device, compare the two inputs, and release the actual input from the user to the application if the inputs are substantially the same.

### FIELD OF INVENTION

Embodiments of the present invention generally relate to systems and methods for training users how to operate handheld electronic devices and their respective applications.

### BACKGROUND OF THE INVENTION

As progress in the technological sector has continued, societies have become increasingly dependent on technology. More particularly, the use of handheld devices has grown to record numbers. For example, it is very common to see the use of pocket PCs, delivery information acquisition devices, personal digital assistants, handheld computers, and the like in the performance of employment-related activities. As should be apparent, though, handheld devices not only improve work-related productivity but can provide for personal conveniences as well.

Interestingly, with the plethora of new handheld devices and applications, there has been little focus on adequately training users how to operate the various devices and their respective applications. To date, much of the training for handheld devices has been performed by instructors (live or recorded) showing or explaining how to operate a given device and then expecting the user to put into practice, on the job, what he or she was taught. Studies show, however, that one of the most effective ways to learn how to use such devices is to use them in an actual or simulated environment. Thus, there is a need for an effective and efficient technique for training or otherwise teaching users to operate handheld electronic devices and their respective applications in an actual or simulated environment.

### BRIEF SUMMARY OF THE INVENTION

In general, embodiments of the present invention provide an improvement by, among other things, providing an improved technique for training users how to operate handheld electronic devices and/or their respective applications. In particular, according to one embodiment, this may include a computing device displaying instructions for a user to follow, or otherwise respond to, in association with an application executing on the handheld device. In addition to displaying the instructions to the user, the computing device may transmit to the handheld device the input that should be entered by the user in response to the instructions. The user may then enter an input on the handheld device in response to the instructions provided. After the handheld device receives the input from the computing device and the actual input entered by the user, the handheld device may compare the two inputs to determine if they are substantially the same.

If the two inputs are substantially the same, the handheld device may release the user's input to the application executing on the handheld device, after which the handheld device may continue with its normal operation. If the two inputs are not substantially the same, the handheld device may generate and transmit an error message to the computing device indicating that the user did not enter the correct input in response to the instructions. In such a case, the handheld device might not release the input actually entered by the user to the application executing on the handheld. Rather, in response to the error message, the computing device can provide feedback to the user regarding the incorrect input, such as providing additional instructions to the user.

In accordance with one aspect, a system is provided for training a user how to operate a handheld electronic device and/or an application executing thereon. In one embodiment, the system may include a computing device in electronic communication with a handheld electronic device, wherein the computing device may be configured to display instructions for training the user how to operate an application executing on the handheld electronic device and to transmit an expected input associated with the application to the handheld electronic device. In this embodiment, the handheld electronic device of the system may be configured to receive the expected input from the computing device, as well as an actual input associated with the application and initiated by the user of the handheld electronic device. The handheld electronic device may be further configured to determine if the expected input and the actual input are substantially the same, to release the actual input to the application being executed on the handheld electronic device upon a determination that the expected input and the actual input are substantially the same, and to generate and transmit an error message to the computing device in response to a determination that the expected input and the actual input are not substantially the same.

In accordance with another aspect, a system is provided, which, in one embodiment, may include a computing device configured to transmit an expected input associated with the application, and a handheld electronic device in electronic communication with the computing device configured to receive the expected input from the computing device, as well as an actual input associated with the application and initiated by the user of the handheld electronic device. The handheld electronic device of this system may be further configured to determine if the expected input and the actual input are substantially the same, and to release the actual input to the application being executed on the handheld electronic device upon a determination that the expected input and the actual input are substantially the same.

In accordance with yet another aspect, a method is provided, which, in one embodiment, may include: establishing a connection between a handheld electronic device and a computing device; receiving an expected input at the handheld electronic device from the computing device, wherein the expected input is associated with an application being executed on the handheld electronic device; receiving an actual input initiated by a user of the handheld electronic device, wherein the actual input is associated with the application being executed on the handheld electronic device; determining if the expected input and the actual input are substantially the same; and releasing the actual input to the application being executed on the handheld electronic device in response to a determination that the expected input and the actual input are substantially the same.

According to another aspect, a computer-implemented method for training a user to operate a package delivery application executing on a handheld delivery information acquisition device is provided. In this embodiment, the computer-implemented method may include: establishing a connection between a handheld delivery information acquisition device and a computing device; receiving an expected input at the handheld delivery information acquisition device from the computing device, wherein the expected input is associated with a package delivery application being executed on the handheld delivery information acquisition device; receiving an actual input initiated by a user of the handheld delivery information acquisition device, wherein the actual input is associated with the package delivery application being executed on the handheld delivery information acquisition device; determining if the expected input and the actual input are substantially the same; and releasing the actual input to the package delivery application being executed on the handheld delivery information acquisition device in response to a determination that the expected input and the actual input are substantially the same.

In yet another aspect, an apparatus is provided, which, in one embodiment, may include a processor configured to: establish a connection with a computing device; receive, from the computing device, an expected input associated with an application currently being executed on the apparatus; receive an actual input initiated by a user of the application, wherein the actual input is associated with the application being executed on the apparatus; determine if the expected input and the actual input are substantially the same; and release the actual input to the application being executed on the apparatus in response to a determination that the expected input and the actual input are substantially the same.

In still yet another aspect, a computer program product is provided, which contains at least one computer-readable storage medium having computer-readable program code portions stored therein. The computer-readable program code portions of one embodiment may include: a first executable portion configured to receive, from a computing device, an expected input associated with an application being executed on a handheld electronic device; a second executable portion configured to receive an actual input initiated by a user of the handheld electronic device, wherein the actual input is associated with the application being executed on the handheld electronic device; a third executable portion configured to determine if the expected input and the actual input are substantially the same; and a fourth executable portion configured to release the actual input to the application being executed on the handheld electronic device in response to a determination that the expected input and the actual input are substantially the same.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an embodiment of a system for training users how to operate handheld devices.

FIG. 2 is a block diagram of an embodiment of a computing device that can be used to train users how to operate handheld devices.

FIG. 3 is a block diagram of a handheld electronic device on which a user may be trained in accordance with embodiments of the present invention.

FIGS. 4-5 are flowcharts illustrating example operations for training users how to operate handheld electronic devices in accordance with an embodiment of the present invention.

FIGS. 6-15 show universal input and output produced by one embodiment of the computing device during training.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### General Overview

In general, according to embodiments of the present invention, methods, apparatus, systems, and computer program products are provided for guiding, prompting, showing, teaching, or training (hereinafter used interchangeably) users how to operate handheld electronic devices and/or their respective applications. This approach may include using both the handheld device and a computing device. For instance, the computing device may display instructions for a user to follow, or otherwise respond to, in using an application, such as a package delivery application, executing on the handheld device. In addition to displaying the instructions to the user, the computing device may transmit (e.g., message) to the handheld device the input that should be entered by the user in response to the instructions. The user may then enter an input on the handheld device in response to the instructions provided. After the handheld device receives the input from the computing device and the actual input entered by the user, the handheld device may compare the two inputs to determine if they are substantially the same. If the two inputs are substantially the same, the handheld device may release the user's input to the application executing on the handheld device, after which the handheld device may continue with its normal operation. If the two inputs are not substantially the same, the handheld device may generate and transmit an error message to the computing device indicating that the user did not enter the correct input in response to the instructions. In such a case, the handheld device does not generally release the input actually entered by the user to the application executing on the handheld. Rather, in response to the error message, the computing device can provide feedback to the user regarding the incorrect input, such as providing additional instructions to the user. These operations can be repeated by the computing device and handheld to guide the user through as much or as little of an application or operation of the handheld device as desired. This technique may provide a hands-on approach for teaching users how to operate handheld devices and their applications in an actual or simulated environment, using the “live” applications of a given handheld device.

### System Architecture

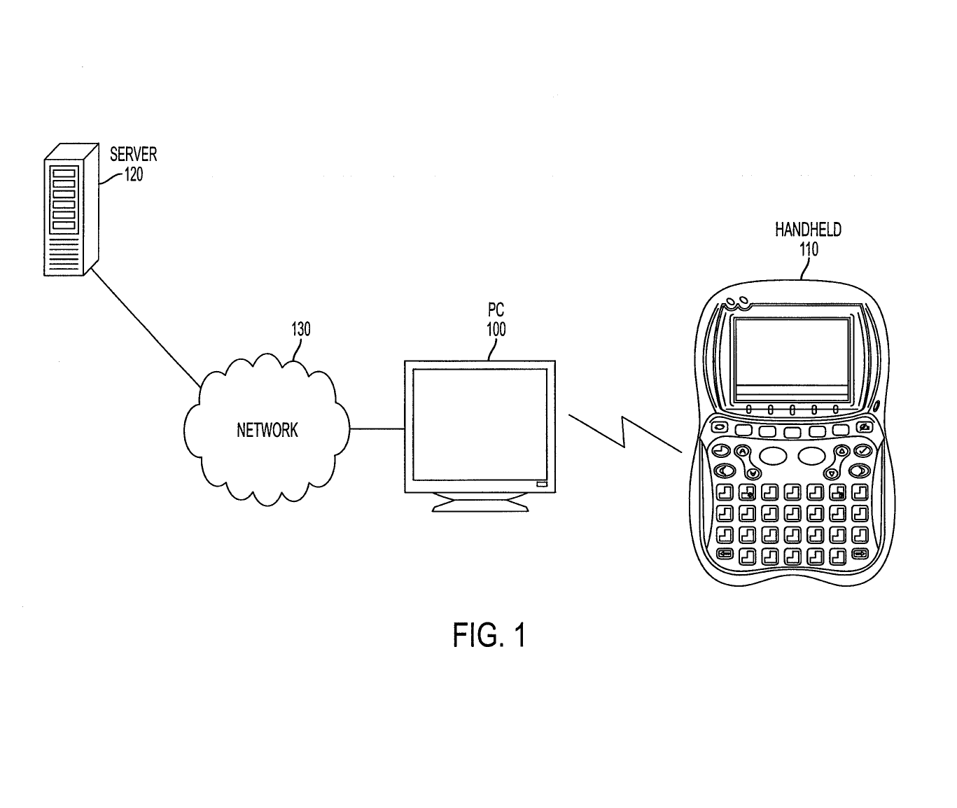

FIG. 1 provides an illustration of one type of system that could be used in conjunction with the embodiments of the present invention. As shown in FIG. 1, the system may include a computing device 100 (“PC”), a handheld electronic device 110 (“handheld”), a server 120, and a network 130. The term “PC” is used generically throughout to refer to any computer, mainframe, desktop, notebook or laptop, distributed system, gateway, router, switch, or any other processing device configured to perform the functions described herein. As will be understood from FIG. 1, the PC 100 can be connected to one or more networks (e.g., a local area network (“LAN”), a metropolitan area network (“MAN”), a wide area network (“WAN”), a private network, or the Internet) to communicate with other computing entities, such as the sever 120 and/or the handheld 110. This communication can be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the PC 100 may be configured to communicate via wireless external communication networks using any of a variety of protocols, such as 802.11, general packet radio service (“GPRS”), wideband code division multiple access (“W-CDMA”), or any other wireless protocol.

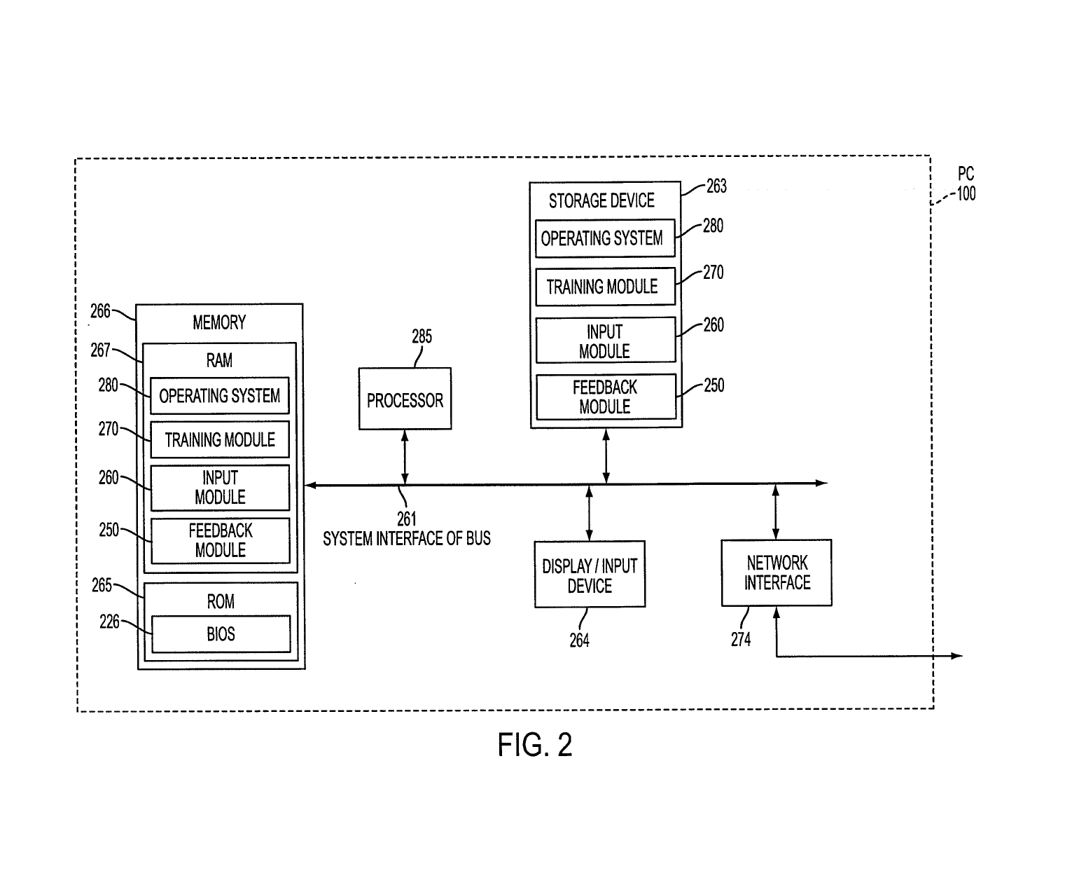

The functionality of the PC 100 may be carried out in a variety of ways. For example, the functionality of the PC 100 may be embodied in a distributed computing system in which various functions can be implemented through separate computing entities. These separate computing entities can be located locally or remotely from one another. For instance, as shown in FIG. 1, the PC 100 may communicate with one or more servers 120 via the network 130. In one embodiment, one or more of the servers 120 can comprise a learning management system (“LMS”) hosted, in part, to provide content for display and/or program code for execution by the PC 100. Alternatively, or in addition, as shown in FIG. 2, some of the functionality of the PC 100 may be implemented via modules, such as a training module 270, an input module 260, and a feedback module 250. As will be recognized, the described architectures are provided for exemplary purposes only and are not limiting to the various embodiments. In this regard, although various program modules are described, the software need not be modularized.

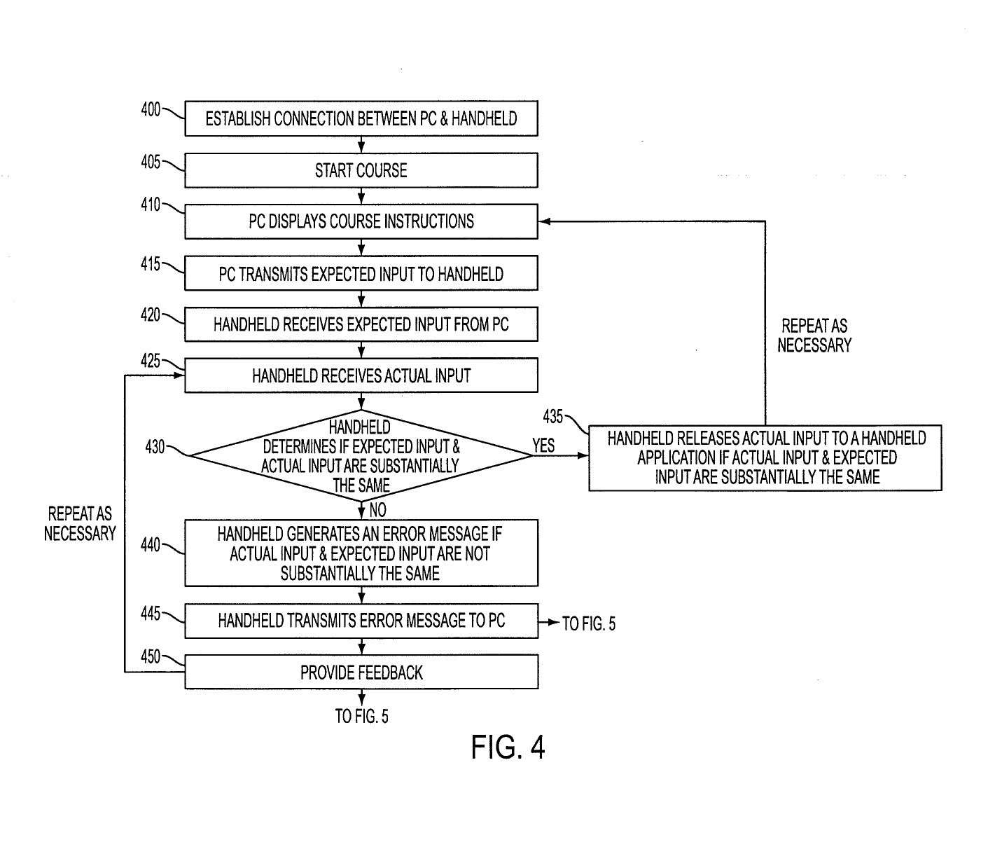

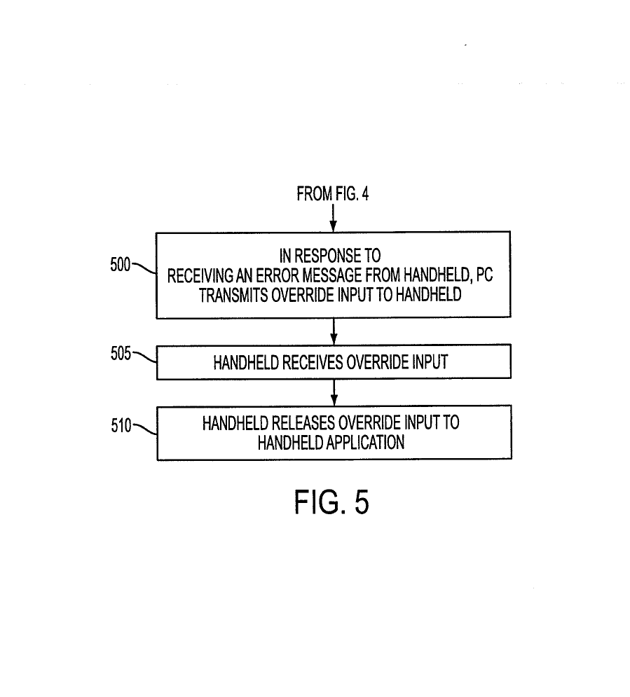

As will also be understood from FIG. 2, the PC 100 may include various other elements/components. For example, the PC 100 may include a processor 285 that communicates with other elements within the PC 100 via a system interface or bus 261. As is discussed in more detail below with regard to FIGS. 4 and 5, the processor 261 may be configured to perform the operations for training a user on a handheld electronic device 110. In particular, according to one embodiment, the processor 261 may be configured to display instructions to the user regarding operation of the handheld 110, transmit an expected input to the user, and provide feedback to the user based on the user's responses. The PC 100 may also include a display/input device 264 for receiving and displaying data. This display/input device 264 may be, for example, a keyboard or pointing device used in combination with a monitor. The PC 100 may further include memory 266, which may include both read only memory (“ROM”) 265 and random access memory (“RAM”) 267. The PC's ROM 265 can be used to store a basic input/output system 226 (“BIOS”), containing the basic routines that help to transfer information between elements within the PC 100.

In addition, the PC 100 may include a storage device 263, such as a hard disk drive, a floppy disk drive, a CD ROM drive, or an optical disk drive, for storing information on various computer-readable media, such as a hard disk, a removable magnetic disk, or a CD-ROM disk. As will be appreciated, each of these storage devices 263 may be connected to the system bus 261 by an appropriate interface. The storage devices 263 and their associated computer-readable media provide nonvolatile storage. The computer-readable media described above could be replaced by any other type of computer-readable media, e.g., magnetic cassettes, flash memory cards, and/or digital video disks. A number of programs and modules may be stored by the various storage devices and within RAM 267. Such programs and modules may include a training module 270, an input module 260, a feedback module 250, and an operating system 280. The training module 270, input module 260, and feedback module 250 may control certain aspects of the operation of the PC 100, with the assistance of the processor 285 and operating system 280. For example, the training module 270 can provide (e.g., display) instructions to the user regarding how to user the handheld 110 and/or its applications. The input module 260 may be used to provide actual input and/or override input to the handheld 110. And the feedback module 250 may provide feedback to the user based on his/her responses to the instructions provided by the PC 100.

Also located within the PC 100 may be a network interface 274 for interfacing and communicating with other elements of a computer network, such as the handheld 110. It will be appreciated that one or more of the PC's 100 components may be located remotely from other PC 100 components. Furthermore, one or more of the components may be combined and additional components performing functions described herein may be included in the PC 100.

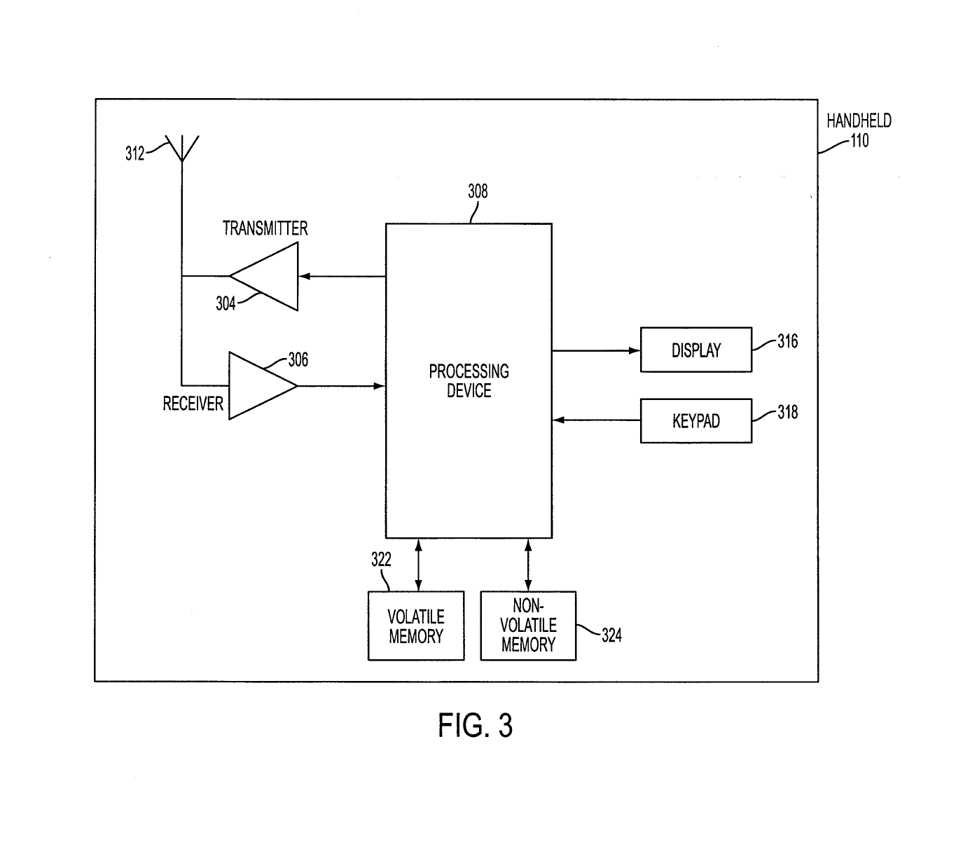

With respect to the handheld 110, FIG. 3 provides an illustrative schematic representative of a handheld 110 that can be used in conjunction with the embodiments of the present invention. The term “handheld” is used generically throughout to refer to any handheld electronic device, such as a pocket PC, delivery information acquisition device (“DIAD”), personal digital assistant (“PDA”), handheld computer, smartphone, portable media player, camera, laptop, pager, converged device, handheld game console, personal navigation device, and the like—including both wireless and wireline devices. As shown in FIG. 3, the handheld 110 can include an antenna 312, a transmitter 304, a receiver 306, and means, such as a processing device 308, e.g., a processor, controller, or the like, that provides signals to and receives signals from the transmitter 304 and receiver 306, respectively. As discussed in greater detail below with FIGS. 4 and 5, the processing device 308 may be configured to perform the operation for training a user to use the handheld 110 and/or application executing thereon. In particular, according to one embodiment, the processing device 308 may be configured to receive an expected input associated with the application currently being executed on the handheld. The processing device 308 may be configured to receive an actual input associated with the application from the user. After receiving both inputs, the processing device 308 may be further configured to determine if the expected input and the actual input are substantially the same and release the actual input to the application in response to a determination that the expected input and the actual input are substantially the same.

The signals provided to and received from the transmitter 304 and the receiver 306, respectively, may include signaling information in accordance with an air interface standard of applicable wireless systems. In this regard, the handheld 110 may be capable of operating with one or more air interface standards, communication protocols, modulation types, and access types. More particularly, the handheld 110 may operate in accordance with any of a number of second-generation (“2G”) communication protocols, third-generation (“3G”) communication protocols, and/or the like. Further, for example, the handheld 110 may operate in accordance with any of a number of different wireless networking techniques, including Bluetooth, IEEE 802.11 (“Wi-Fi”), 802.16 (“WiMAX”), ultra wideband (“UWB”), and/or the like. Via these communication standards and protocols, the handheld 110 can communicate with the PC 100. The handheld can also download changes, add-ons, and updates, for instance, to its firmware, software (e.g., including modules), and operating system.

The handheld 110 may also comprise a user interface (that can include a display 316 coupled to a processing device 308) and/or a user input interface (coupled to the processing device 316). The user input interface can comprise any of a number of devices allowing the handheld 110 to receive data, such as a keypad 318, a touch display (not shown), barcode reader (not shown), radio frequency identification (“RFID”) tag reader (not shown), or other input device. In embodiments including a keypad 318, the keypad 318 can include the conventional numeric (0-9) and related keys (#, *), and other keys used for operating the handheld 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Although not shown, the handheld 110 may also include a battery, such as a vibrating battery pack, for powering the various circuits that are required to operate the handheld 110, as well as optionally providing mechanical vibration as a detectable output.

The handheld 110 can also include volatile memory 322 and/or non-volatile memory 324, which can be embedded and/or may be removable. For example, the non-volatile memory may be embedded or removable multimedia memory cards (“MMCs”), secure digital (“SD”) memory cards, Memory Sticks, EEPROM, flash memory, hard disk, or the like. The memory can store any of a number of pieces or amount of information and data used by the handheld 110 to implement the functions of the handheld 110. For example, the volatile and non-volatile memory can be used to temporarily or permanently store input from the computing device and/or input entered by the user via the user input interface. The memory can also store content, such as computer program code for an application and/or other computer programs. For example, the memory may store computer program code for instructing the processing device 308 to perform operations discussed above and below with regard to FIGS. 4 and 5 to train the user to use the handheld 110 and/or applications executing thereon. The applications for execution on the handheld 110 may include a package delivery application, a merchandise return application, a product request application, and/or the like. The functionality, interaction, and operations executed by the PC 100 and/or handheld 110 in accordance with various embodiments of the present invention are described in the following sections.

### Method of Training

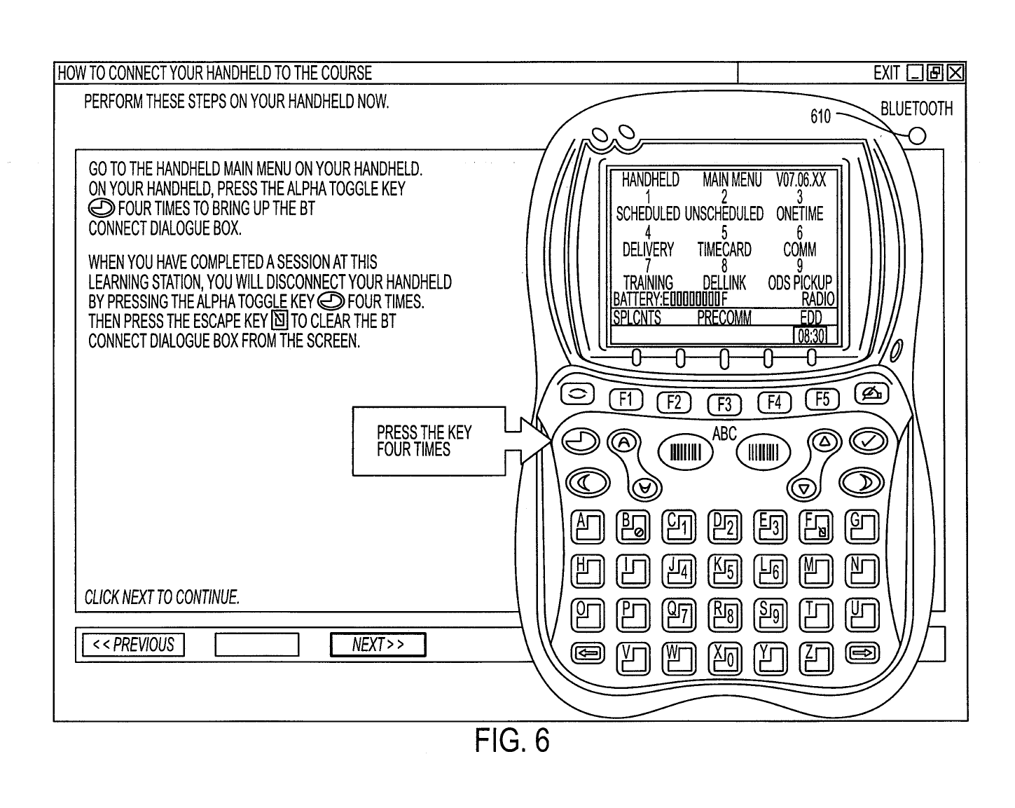

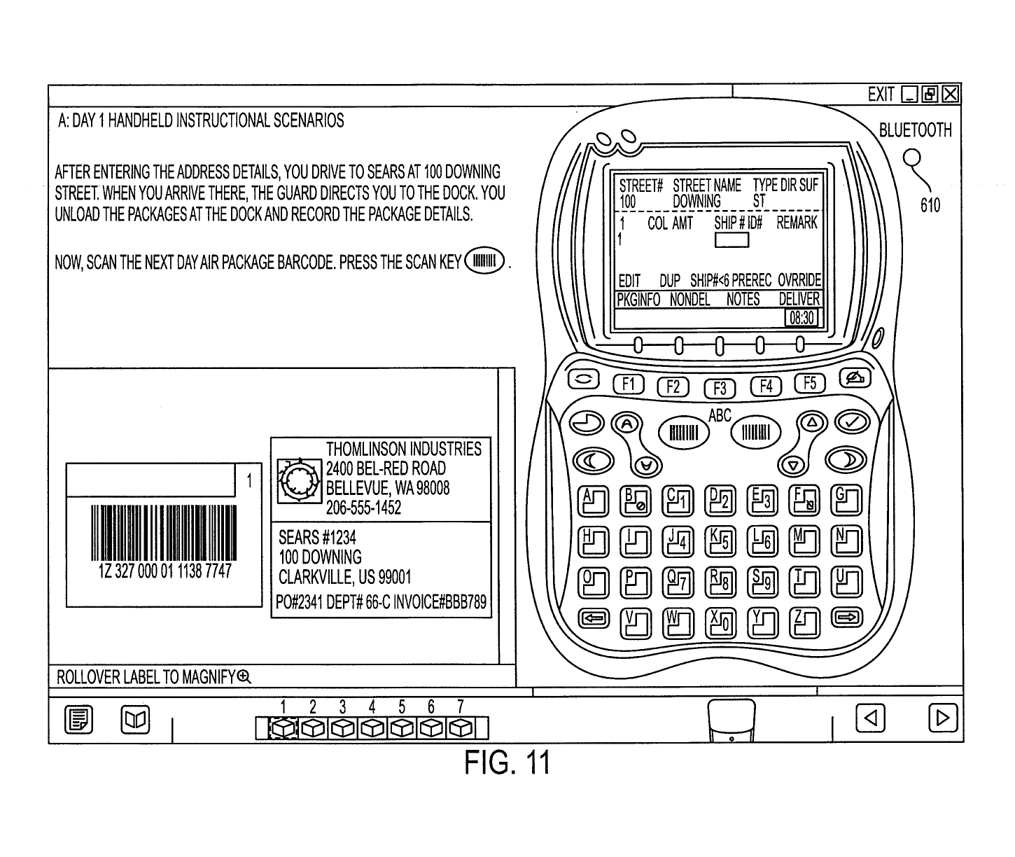

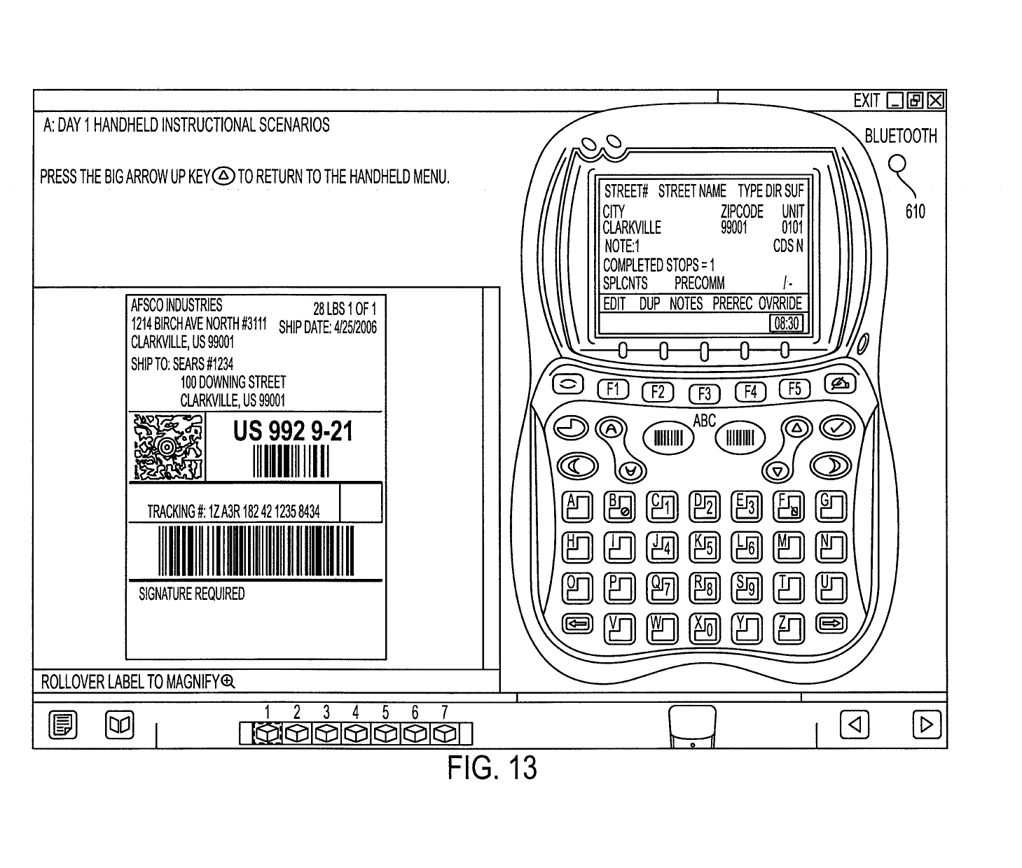

Reference will now be made to FIGS. 4-15, which provide one example of operations and input and output produced by various embodiments of the present invention. In particular, FIGS. 4-5 provide flowcharts illustrating operations which may be performed to aid in training a user how to operate a handheld 110 and/or its applications. These operations will hereinafter be described in conjunction with FIGS. 6-15, which illustrate input and output which may be produced by one embodiment of the computing device carrying out selected operations recited in FIGS. 4-5. The described process includes training a user how to operate a handheld 110 executing a package delivery application (“application”). As one of ordinary skill in the art will recognize, embodiments of the present invention may likewise be used to operate a handheld 110 executing other types of applications, such as a merchandise return application, a product request application, and/or the like. That is, the described handheld 110 and application are described for exemplary purposes and are not limiting to the various embodiments.

As shown in FIG. 4, the process may begin at Block 400. At Block 400, the user establishes a connection between the PC 100 and the handheld 110. In this operation, the PC 100 can display the connection operations to guide the user through the appropriate actions to wirelessly connect to the PC 100 (as shown in FIG. 6). The user, though, may choose to skip review of these operations if desired. In one embodiment, the handheld 110 may serve as the master device to help prevent unwanted wireless connections to it from other computing devices. Thus, to initiate a connection to the PC 100, various connect triggers can be activated on the handheld 110. For instance, as shown in FIG. 6, an Alpha Toggle key can be pressed four times to begin the connection process—this connect trigger can also serve to activate the training software/hardware on the handheld 110. The connection process can be implemented in various ways. Illustratively, the handheld 110 can be programmed to connect to a particular PC 100, search for available connections, and/or allow the user to select the PC 100 to which the handheld should connect. With regard to the latter, in a training setting with, for example, ten PCs 100 and ten handhelds 110, each handheld 110 could store the media access control (“MAC”) address for each PC 100 in association with an assigned PC number (e.g., PC #2: 00-14-85-0D-37-29). Thus, a user assigned to use PC #2 could enter “2” (e.g., manually or via a drop-down menu) on the handheld 110 at the appropriate screen, after which the handheld 110 could use the stored MAC address (e.g., 00-14-85-0D-37-29) to connect to PC #2. If the connection is successful, the PC 100 can change a status indicator light 610 (e.g., an icon) displayed on the PC 100 from red to green, indicating that the devices are connected. Similarly, the handheld 110 could also provide an indication to the user that the connection was successful. Although the foregoing describes a wireless connection between the handheld 110 and the PC 100, such as Bluetooth®, the handheld 110 could connect to the PC 100 via a wired connection as well.

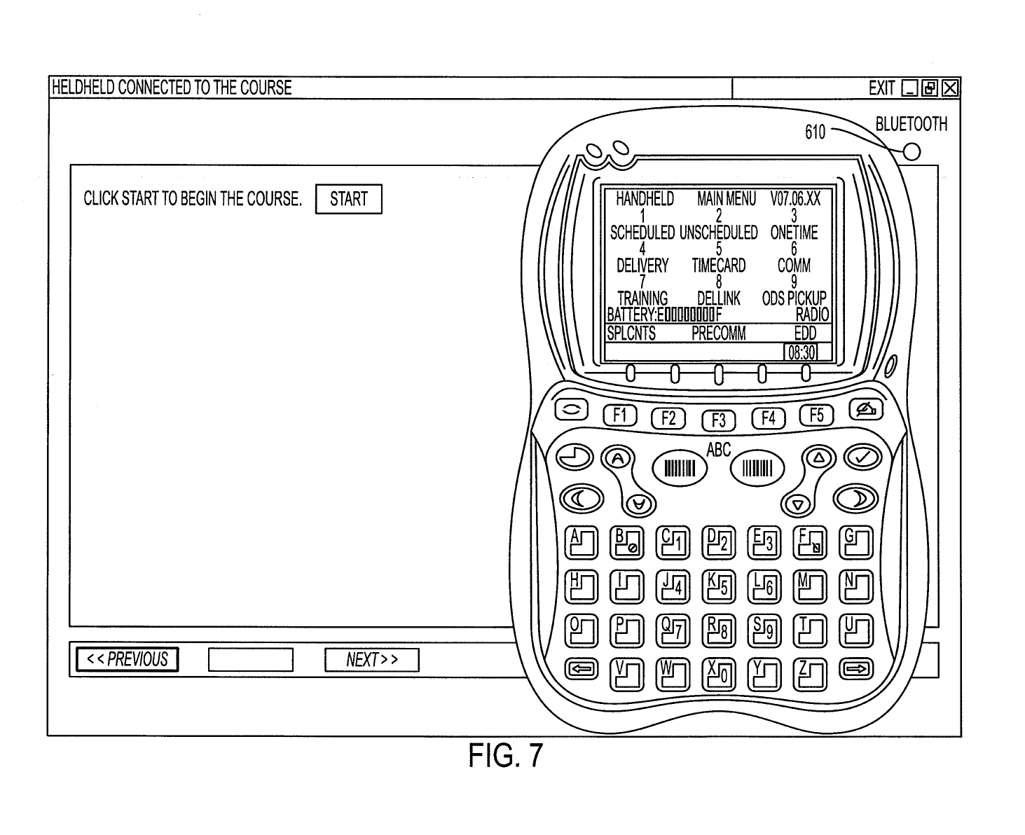

After a connection is established, the user can select to begin the training course as indicated in FIG. 7 and Block 405 of FIG. 4. Once the user has begun the course, the PC 100 may, at Block 410, display instructions for operating the handheld 110 or application. For example, as will be described in greater detail, the PC 100 may provide instructions that walk the user step-by-step through use of an application executing on the handheld. For example, the PC 100 may display the first instruction for using an application in which the user is being trained, such as a package delivery application. In the various embodiments, the PC 100 can provide the instructions in multiple formats, including text, audio, and/or audio-video presentations. In one embodiment, the instructions may be provided by the PC 110 in operation with the training module 270. Further, the level and detail of the instructions may vary with the skill level of the user. For instance, a skilled user participating in the training to learn a new feature on the handheld 110 or new version of software may need very few instructions, if any. In such a case, the PC 100 could present the user with a real-world scenario and allow him to move forward with the course with minimal instructions. Moreover, the training course can be executed in training or testing mode. Generally, training mode may provide more instructions, e.g., helpful hints and the like, to the user than the testing mode. Testing mode, on the other hand, may be used to model real-world scenarios with few or no instructions and may track the efficiency and accuracy of the user. However, as should be recognized, various combinations of the two modes are contemplated within the scope of the embodiments of the present invention.

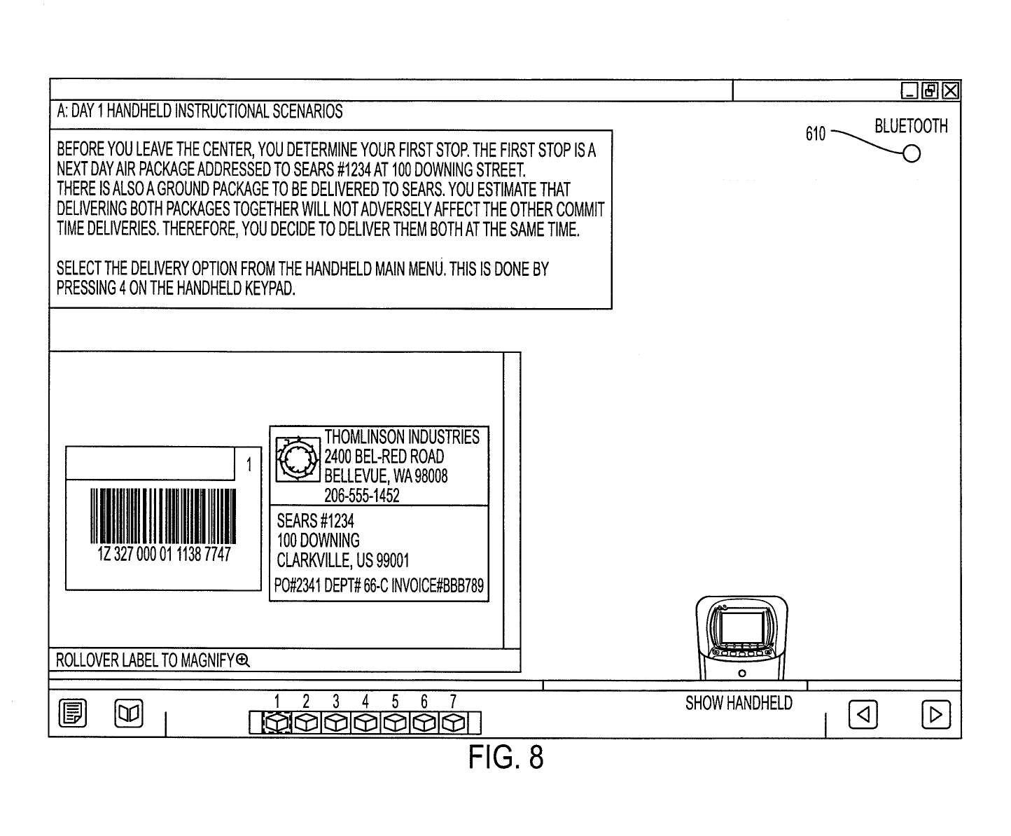

In addition to providing instructions to the user, the PC 100 can display a progress bar indicating the user's progress in, for example, the training course. The PC 100 can also be configured to allow the user to select the option of displaying an image of the handheld 110 as it tracks the training course or to keep the handheld 110 out of view, e.g., minimized, as shown in FIGS. 8-10. From a training perspective, the student may learn more effectively by keeping the handheld 110 minimized so that he focuses on using the actual handheld 110.

With respect to the instructions provided in the above example, as the first instruction provided, the PC 100 may display instructions of how to input package delivery information into the handheld 110. More specifically, as shown in FIG. 8, the PC 100 may provide instructions to select the delivery option from the main menu by pressing “4” on the keypad.

In addition to providing instructions for operating the handheld 110 or application executing thereon, at Block 415, the PC 100 may transmit the “expected input” of the user to the handheld 110. In one embodiment, the PC 100 may transmit the expected input to the handheld 110 in operation with the input module 260. The expected input is the correct input that should be entered by the user in response to the instructions provided by the PC 100. In the above example, the PC 100 may message the handheld 110 that the expected input is “4” (Block 415). The term “messaging” may involve transmitting an information unit to or by a computing entity with information about the status of an operation, an error, other condition, and/or the like. At Block 420, the handheld may receive the expected input from the PC 100, e.g., via the wireless connection established at Block 400.

After reviewing the instructions on the PC 100, the user may enter an actual input via the handheld 110 (Block 425). As mentioned, the user's response/input is referred to as the “actual input.” The user can provide the actual input to the handheld 110 in various ways, for example, including by pressing a key on a keypad (“key press”) and/or using a stylus to input information via the display. Irrespective of the mechanism the user employs to provide the actual input to the handheld 110, at some point, the handheld 110 should have received the expected input from the PC 100 and the actual input from the user. The handheld 110 can then determine if the expected input and the actual input are “substantially the same” to evaluate if the user responded correctly to the instructions or real-world scenario provided by the PC 100 (Block 430). In one embodiment, the determination may be made on a character-by-character basis, wherein each actual input character is compared to the corresponding expected input character. In another embodiment, the determination may be made based on a string of characters, wherein it is determined whether the actual input string is substantially the same as the expected input string. In yet another embodiment, the determination may be made on a portion of a string of characters, wherein it is determined whether the expected input is substantially the same as a specific portion of the actual input string. For example, a substantial similarity determination could be made on the first five characters of an eighteen character actual input string. Thus, the expected input may be the first five characters of the string that should be entered by the user, and the actual input may be an eighteen character string (e.g., 1Z A3R 182 42 1235 8434). In this embodiment, a substantial similarity determination can be made by comparing all five characters of the actual input (e.g, “1ZA3R”) to the first five characters (e.g, “1ZA3R”) of the eighteen character actual input string (e.g., 1Z A3R 182 42 1235 8434).

Moreover, in some embodiments, the expected input and the actual input need only be “substantially the same” to compensate for expected or reasonable variations of input. For example, if the PC 100 messages the handheld 110 that the expected input is “F” and the user enters “f” as the actual input, the handheld 110 can be configured to make a determination that “F” and “f” are substantially the same for applications that are not case-sensitive. For applications that are case sensitive, the handheld can, of course, be configured to make a determination that “F” and “f” are not substantially the same. In short, the term substantially the same may include both identical matches and/or expected or reasonable variations of the input. In fact, the scope of the input variations can be defined as broadly or as narrowly as desired.

Continuing with the above example, if the user were to input “5” as the actual input, the handheld 110 would have an expected input of “4” and an actual input of “5.” After receiving both inputs, in this instance, the handheld 110 may make a determination that the expected input and the actual input are not substantially the same (Block 430).

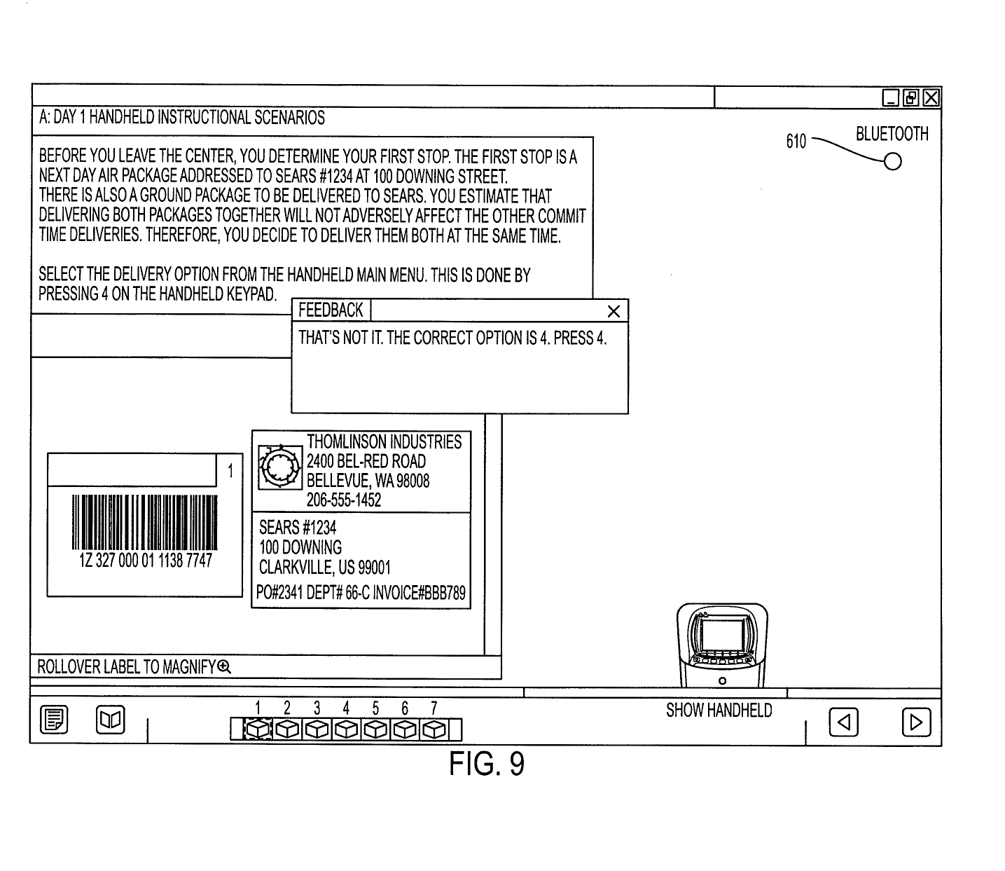

In response to determining that the actual and expected inputs are not substantially the same, the handheld 110 can generate and transmit an error message to the PC 100 indicating that the actual input and the expected input are not substantially the same, e.g., that the actual input was incorrect (Blocks 440 and 445 respectively). In one embodiment, generating and transmitting the error message can comprise messaging the PC 100 that the actual input was incorrect (e.g., transmitting a packet with an indicator flag changed from false (“0”) to true (“1”)). In another embodiment, generating and transmitting the error message may comprise messaging the PC 100 that the actual input was incorrect and also transmitting the actual input entered by the user. Transmitting the actual input of the user with the error message may be useful for providing more detailed feedback. In either instance, though, the PC 100 can provide various forms of feedback to the user, including text, audio, and/or audio-video presentations. In one embodiment, the PC 100 may provide the feedback in operation with the feedback module 250. In the above example, as shown in FIG. 9, the PC 100 may provide a message that reads “That's not correct. The correct option is 4, Press 4.” Similarly the feedback provided by the PC 100 could read “That's not correct. The correct option is 4. You pressed 5.” In short, the feedback can be as abstract or elaborate as desired. For more comprehensive feedback, the PC 100 can provide additional “Help” links that the user can access to research a given topic. This can be provided, for example, to help the user understand why his/her actual input was incorrect.

In one embodiment, if the expected input and the actual input are not substantially the same, the handheld 110 may further not “release” the actual input to the application executing on the handheld 110. In particular, when the training program is executing on the handheld 110, the handheld 110 can temporarily store the user's actual input while determining if it is substantially the same as the expected input. If the handheld 110 determines that the actual input is not substantially the same as the expected input, it may discard or erase the actual input, i.e., not release the actual input to the application. Thus, in the above example, because the user did not enter the correct input, the handheld 110 does not provide the user's actual input to the application. That is, in the above example, the handheld 110 did not release the actual input to the application. It can be beneficial to only release correct actual inputs to an application(s) executing on the handheld 110 for several reasons. For instance, by discarding any incorrect actual input, the user does not learn to operate the handheld 110 or application incorrectly. Moreover, the program code on the PC 100 can usually be simpler. That is, this technique does not require synchronization between the PC 100 and the handheld 110. In these embodiments, the two devices can use a common start location (e.g., the main menu screen) for each training course. By employing a common start location such as the main menu, for example, the PC 100 can be configured to display screens that logically follow the entry of correct input. In other embodiments, though, the PC 100 and the handheld 110 can be synchronized. Synchronization can allow the PC 100 and handheld 110 to communicate status information regarding current program location and/or the like. Further, as should be recognized, in other embodiments, the incorrect actual input can be released to the application and corresponding feedback can be provided by the PC 100, e.g., “That's not correct. The correct option is 4. Press Escape to go back.” For embodiments in which incorrect actual input is not released to the application (for any application, screen, or handheld-related function), Blocks 425-450 can be repeated as necessary until the expected input and actual input are substantially the same, i.e., for until the user enters the correct input. That is, in one embodiment, the PC 100 and handheld 110 can continue repeating the operations described in Blocks 425-450 until the user enters an actual input that is substantially the same as the expected input.

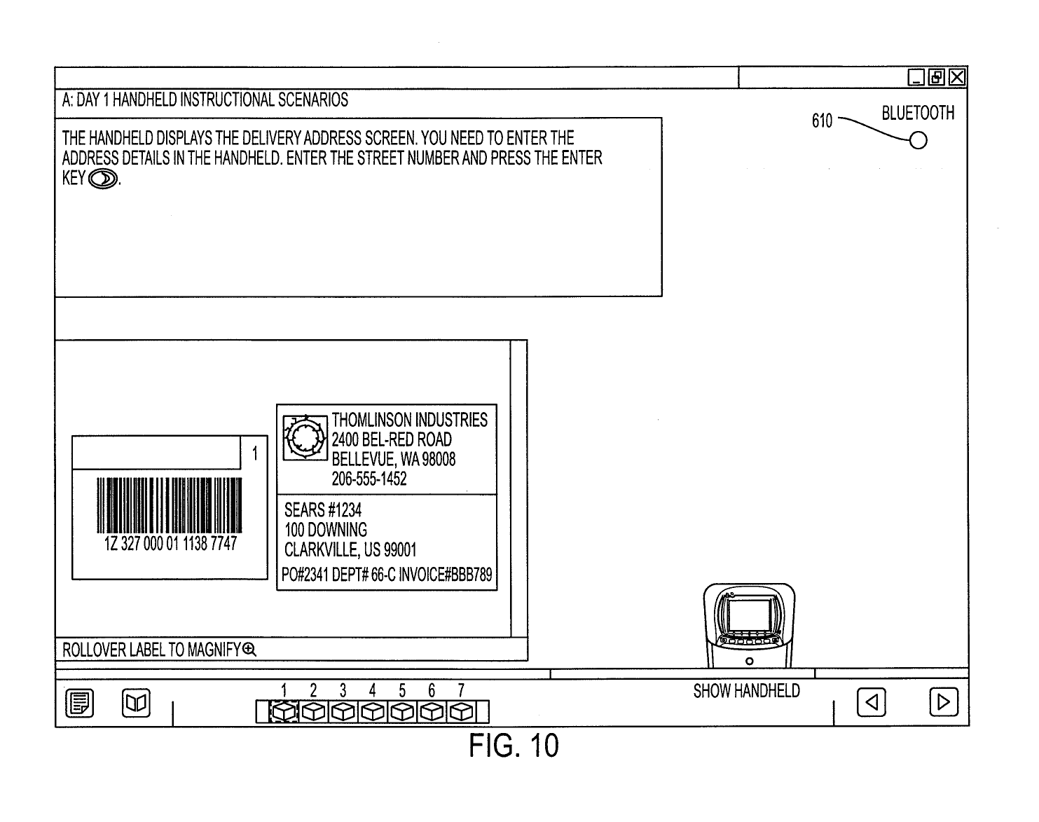

If the expected input and the actual input are substantially the same, the handheld 110 may, at Block 435, release the actual input to the application, after which the application can function in its normal way. In the above example, the handheld 110 may release “4” to the application, and, the application, functioning in its normal way, may then present the user with the next logical screen via the handheld 110, e.g., the delivery address screen. In accordance with Block 410 (i.e., repeating Block 410 after releasing the correct actual input to the handheld 110), the PC 100 may also display a second instruction for using the application in which the user is being trained. For example, the PC 100 may display information relating to the input of information on the delivery address screen, as shown in FIG. 10. Thus, for each step, screen, or handheld-related function, the operations of Blocks 410-450, can be repeated by the PC 100 and handheld 110 as was described above for training the user how to operate the handheld 110 or application.

As mentioned, after the handheld receives an expected input and an actual input that are substantially the same, the PC 100 may, at Block 410, display instructions relating to the next logical step on the handheld 110 and/or application. This could be, for instance, because the PC 100 and the handheld 110 are synchronized or because the PC 100 is configured to follow the operations of the application if correct input is entered. In one embodiment, in addition to releasing the actual input to the application, the handheld 110 can also transmit confirmations to the PC 100 that the actual input was correct. In the present example, however, the handheld 110 does not transmit confirmation messages to the PC 100.

Returning to the above example, repeating the operations of Blocks 410-450, if the user's actual input is “4,” after releasing “4” to the application executing on the handheld 110, the application's normal function may cause the handheld 110 to present the delivery address screen to the user (repeating Block 410). As shown in FIG. 10, the PC 100 may display the address delivery screen instructions that state that the user should “Enter the street number and press the Enter key.” Additionally, as described in detail above, the PC 100 could transmit the expected input to the handheld 110 (repeating Block 415). In the above example, the expected input is “1234.” This expected input (“1234”) can be transmitted, for instance, to the handheld 110 as individual characters or as a string. After receiving the expected input and the actual input (repeating Blocks 420 and 425 respectively), the handheld would determine if the actual input and the expected input are substantially the same (repeating Block 430). Thus, if the handheld 110 determines that the actual and expected inputs are substantially the same, e.g., the user's actual input was “1234,” the actual input may be released to the application for normal operation (repeating Block 435). In the above example, the handheld 110 may release “1234” as the street address for the delivery and proceed with the normal function of the application. The above-described operations can be repeated throughout the training course to train the user in operation of the handheld 110 and/or application. That is, the operations of FIG. 4 (and/or FIG. 5) can be repeated for any step, screen, or handheld-related function as many times as necessary to train the user how to operate the handheld 110 and/or its application.

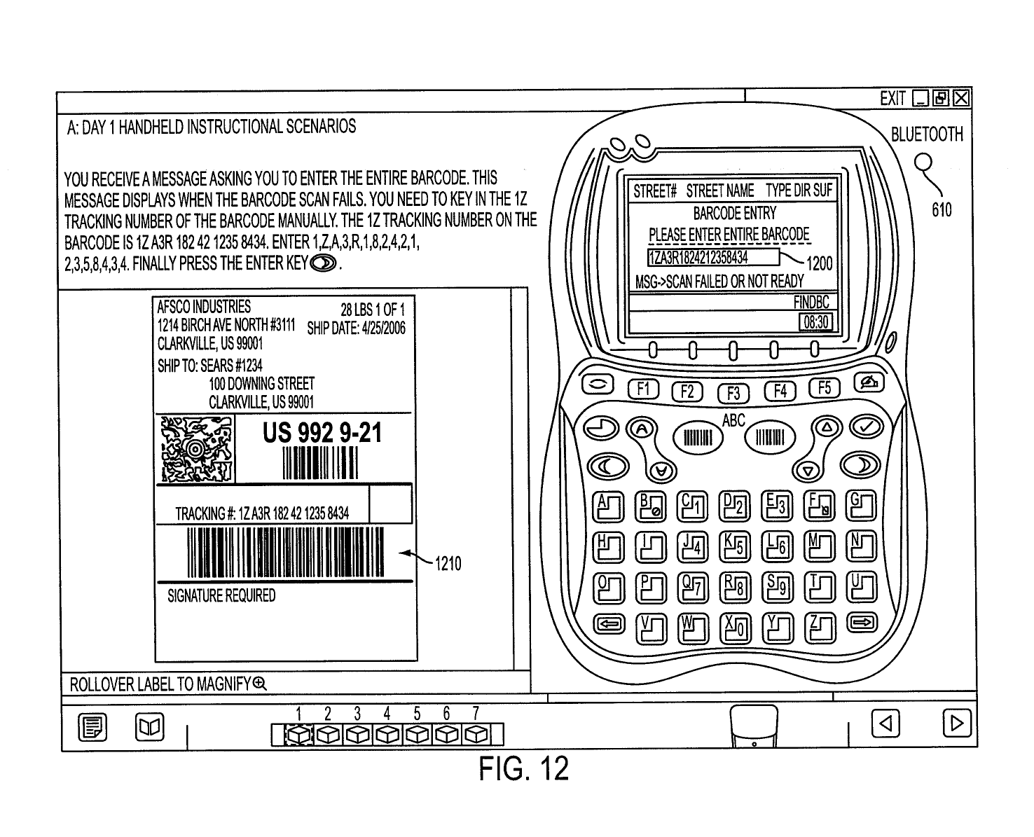

Additionally, during the training course, there could be instances in which it may be helpful to bypass a screen or step on the handheld 110 and/or application. For instance, if the application progressed to a point in which the user needs to scan a barcode label but scanning a barcode label is not feasible, the PC 100 could provide an override input to the handheld 110. For example, the simulated training environment could be configured such that the user is given a bogus barcode label to scan. Under the functionality described in the operations of FIG. 4, the actual input may be the information retrieved from scanning the barcode label. Because the barcode label in the above example is bogus, the handheld 110 may make a determination that the expected input and the actual input are not substantially the same and generate and transmit an error message to the PC 100 (Blocks 430, 440, and 445, respectively). In response to the error message, there are various ways in which the PC 100 could respond. The PC 100 could, for example, display another screen as shown in FIG. 12, requesting the user to manually input the information contained on the barcode label. Alternatively, as shown in Block 500 of FIG. 5, the PC 100 can transmit an override input to the handheld 110. In one embodiment, the PC 100 may provide the override input to the handheld 110 in operation with the input module 260. In the above example, the override input may be the tracking number 1200 (e.g., 1Z A3R 182 42 1235 8434) on the barcode label 1210, as shown in FIG. 12. After receiving the override input from the PC 100, at Block 505, the handheld 110 can release the override input, as opposed to the actual input, to the application (as indicated in Block 510). The operations of Blocks 500-510 may occur so quickly that they are transparent or nearly transparent to the user.

In another embodiment (not shown), the PC 100 could transmit an override input to the handheld 110 with the command to release the override input to the application after receiving the next correct actual input. Thus, in essence, the PC 100 could provide the handheld 110 with an override input in advance of an upcoming point in the application. In this scenario, the handheld 110 can receive a correct actual input and release it to the application, the application may proceed with its normal function, and the handheld 110 may then release the override input to the application after the handheld has proceeded with its normal function, which would essentially bypass the next screen or step. As mentioned, this may be done in a manner this is transparent or nearly transparent to the user. And as should be understood, there are many other ways to transmit and release override inputs. Thus, the above examples are provided for illustrative purposes only and are not limiting to the various embodiments of the present invention.

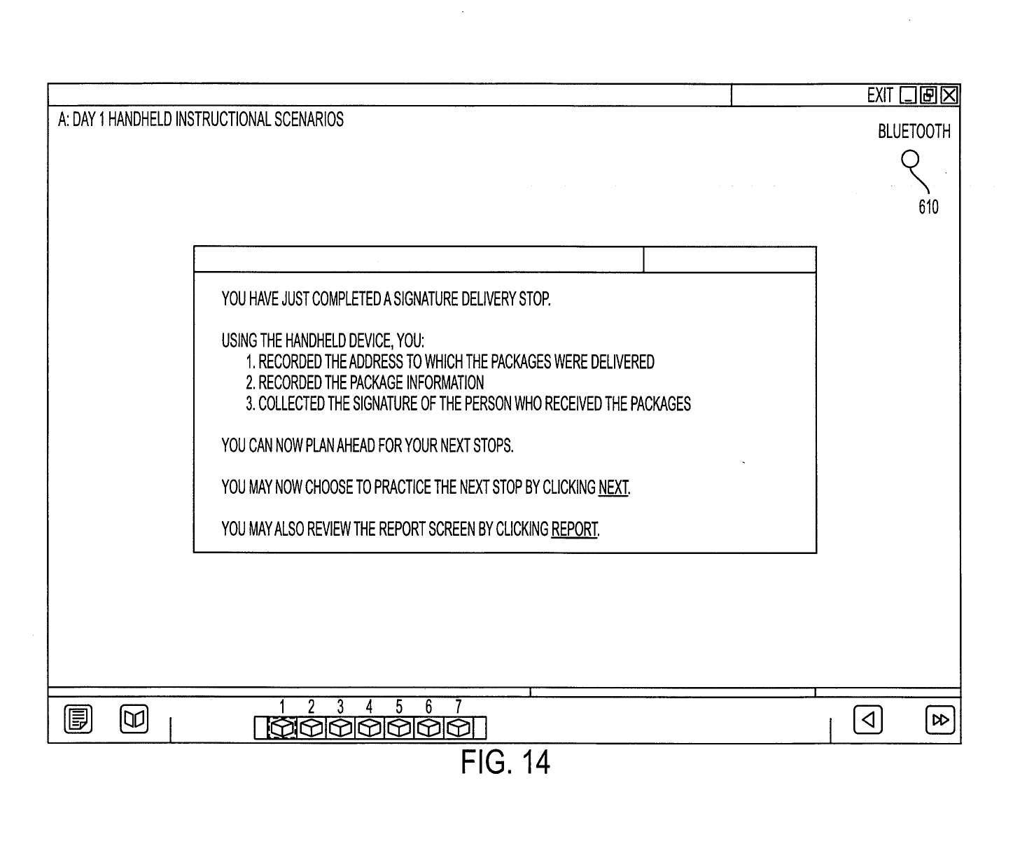

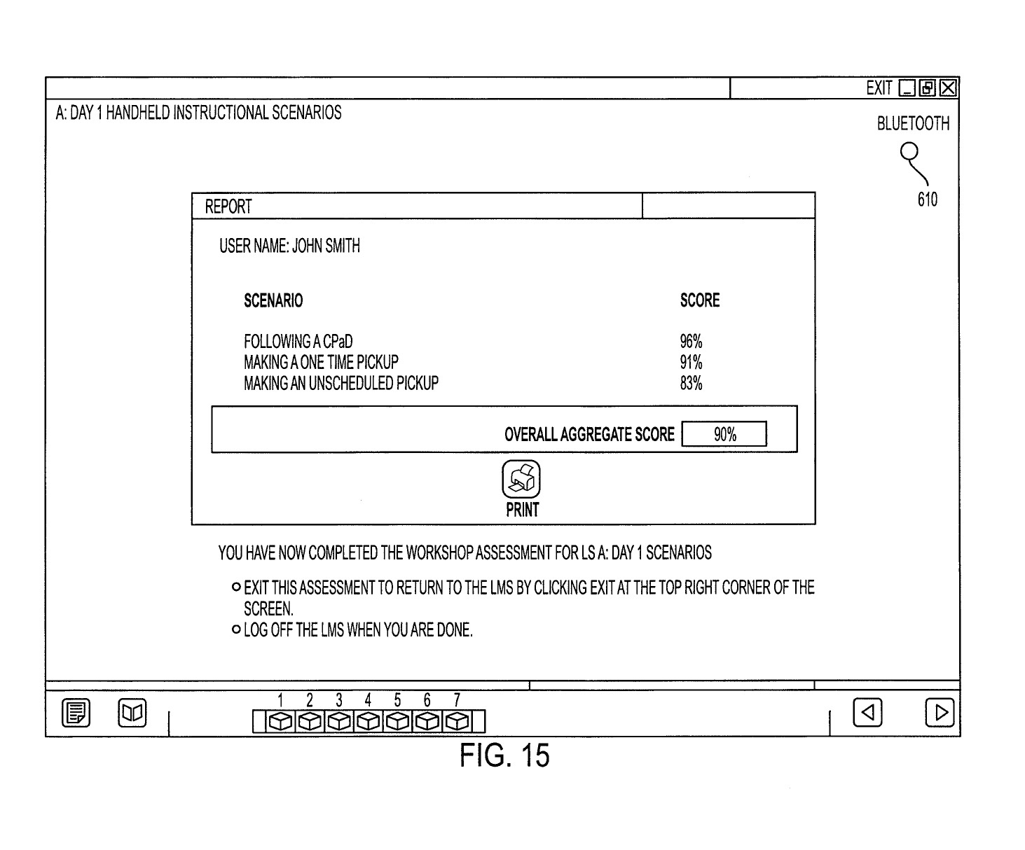

At the conclusion of the training course, or anytime before, the PC 100 can provide the user with various options from which to choose (FIG. 14). For example, the user can choose to proceed with another training course or review reports/results of the training course just completed. Exemplary reports are provided in FIG. 15. The reports can display percentages of correct and incorrect responses, display reports based on particular skill areas, display skill areas that need improvement, display and aggregate the score of all training courses completed, set and display pass/fail criteria, and/or the like. The reports can help the user to track his/her progress and can even be used to determine the user's fitness for completion of a training program.

The foregoing describes effective and efficient methods, systems, apparatus, and computer program products for training or otherwise teaching users to operate handheld electronic devices and their respective applications in an actual or simulated environment. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for training users how to operate handheld electronic devices and their respective applications comprising:
a computing device in electronic communication with a handheld electronic device,
wherein the computing device is configured to:
display instructions for training a user how to operate an application executing on the handheld electronic device; and
transmit an expected input to the handheld electronic device; and
wherein the handheld electronic device is configured to:
receive the expected input from the computing device, wherein the expected input is associated with the application being executed on the handheld electronic device;
receive an actual input initiated by a user of the handheld electronic device, wherein the actual input is associated with the application being executed on the handheld electronic device;
determine if the expected input and the actual input are substantially the same;
release the actual input to the application being executed on the handheld electronic device upon a determination that the expected input and the actual input are substantially the same; and
generate an error message and transmit the error message to the computing device in response to a determination that the expected input and the actual input are not substantially the same.

2. A system comprising:
a computing device configured to:
transmit an expected input; and
a handheld electronic device in electronic communication with the computing device, the handheld electronic device configured to:
receive the expected input from the computing device, wherein the expected input is associated with an application being executed on the handheld electronic device;
receive an actual input initiated by a user of the handheld electronic device, wherein the actual input is associated with the application being executed on the handheld electronic device;
determine if the expected input and the actual input are substantially the same; and
release the actual input to the application being executed on the handheld electronic device upon a determination that the expected input and the actual input are substantially the same.

3. The system of claim 2, wherein the handheld electronic device is further configured to:
generate an error message in response to a determination that the expected input and the actual input are not substantially the same.

4. The system of claim 3, wherein the handheld electronic device is further configured to:
transmit the error message to the computing device.

5. The system of claim 3, wherein the handheld electronic device is further configured to:
transmit the error message and the actual input to the computing device.

6. The system of claim 3, wherein the handheld electronic device is further configured to:
transmit the error message to the computing device;
receive, in response to transmitting the error message to the computing device, an override input from the computing device; and
release the override input to the application being executed on the handheld electronic device.

7. The system of claim 2, wherein the computing device is further configured to:
display instructions for using the application being executed on the handheld electronic device, the instructions associated with the expected input.

8. The system of claim 2, wherein the computing device is further configured to:
receive the error message from the handheld electronic device; and
display feedback in response to receiving the error message.

9. A method comprising:
establishing a connection between a handheld electronic device and a computing device;
receiving an expected input at the handheld electronic device from the computing device, wherein the expected input is associated with an application being executed on the handheld electronic device;
receiving an actual input initiated by a user of the handheld electronic device, wherein the actual input is associated with the application being executed on the handheld electronic device;
determining if the expected input and the actual input are substantially the same; and
releasing the actual input to the application being executed on the handheld electronic device in response to a determination that the expected input and the actual input are substantially the same.

10. The method of claim 9, wherein receiving an expected input further comprises receiving the expected input from a computing device, the method further comprising:
generating an error message in response to a determination that the expected input and the actual input are not substantially the same.

11. The method of claim 10 further comprising:
transmitting the error message to the computing device.

12. The method of claim 10 further comprising:
transmitting the error message and the actual input to the computing device.

13. The method of claim 10 further comprising:
transmitting the error message to the computing device;
receiving, in response to transmitting the error message, an override input from the computing device; and
releasing the override input to the application being executed on the handheld electronic device.

14. The method of claim 9, wherein the expected input comprises a key press.

15. An apparatus comprising:
a processor configured to:
establish a connection with a computing device;
receive, from the computing device, an expected input associated with an application currently being executed on the apparatus;
receive an actual input initiated by a user of the application, wherein the actual input is associated with the application being executed on the apparatus;
determine if the expected input and the actual input are substantially the same; and
release the actual input to the application being executed on the apparatus in response to a determination that the expected input and the actual input are substantially the same.

16. The apparatus of claim 15, wherein the expected input is received from a computing device, and the processor is further configured to:
generate an error message in response to a determination that the expected input and the actual input are not substantially the same.

17. The apparatus of claim 16, wherein the processor is further configured to:
transmit the error message to the computing device.

18. The apparatus of claim 16, wherein the processor is further configured to:
transmit the error message and the actual input to the computing device.

19. The apparatus of claim 16, wherein the processor is further configured to:
transmit the error message to the computing device;
receive, in response to transmitting the error message, an override input from the computing device; and
release the override input to the application being executed on the apparatus.

20. The apparatus of claim 15, wherein the expected input comprises a key press.

21. A computer program product comprising at least one computer-readable storage medium having computer-readable program code portions stored therein, the computer-readable program code portions comprising:
a first executable portion configured to receive, from a computing device, an expected input associated with an application being executed on a handheld electronic device;
a second executable portion configured to receive an actual input initiated by a user of the handheld electronic device, wherein the actual input is associated with the application being executed on the handheld electronic device;
a third executable portion configured to determine if the expected input and the actual input are substantially the same; and
a fourth executable portion configured to release the actual input to the application being executed on the handheld electronic device in response to a determination that the expected input and the actual input are substantially the same.

22. The computer program product of claim 21, wherein the expected input is received from a computing device, the computer program product further comprising:
a fifth executable portion configured to generate an error message in response to a determination that the expected input and the actual input are not substantially the same.

23. The computer program product of claim 22 further comprising:
a sixth executable portion configured to transmit the error message to the computing device.

24. The computer program product of claim 23 further comprising:
a sixth executable portion configured to transmit the error message and the actual input to the computing device.

25. The computer program product of claim 24 further comprising:
a sixth executable portion configured to transmit the error message to the computing device;
a seventh executable portion configured to receive, in response to transmitting the error message, an override input from the computing device; and
an eighth executable portion configured to release the override input to the application being executed on the handheld electronic device.

26. The computer program product of claim 21, wherein the expected input comprises a key press.

27. A computer-implemented method for training a user to operate a package delivery application executing on a handheld delivery information acquisition device comprising:
establishing a connection between a handheld delivery information acquisition device and a computing device;
receiving an expected input at the handheld delivery information acquisition device from the computing device, wherein the expected input is associated with a package delivery application being executed on the handheld delivery information acquisition device;
receiving an actual input initiated by a user of the handheld delivery information acquisition device, wherein the actual input is associated with the package delivery application being executed on the handheld delivery information acquisition device;
determining if the expected input and the actual input are substantially the same; and
releasing the actual input to the package delivery application being executed on the handheld delivery information acquisition device in response to a determination that the expected input and the actual input are substantially the same.
